(19) United States
(12) Patent Application Publication
(10) Pub. No.: US 2024/0222708 A1
(43) Pub. Date: Jul. 4, 2024

(54) METHOD OF PREPARING ELECTROCHEMICAL DEVICE AND ELECTROCHEMICAL DEVICE

(71) Applicant: MICROVAST, INC., Stafford, TX (US)

(72) Inventors: YANG WU, Honolulu, HI (US); WENJUAN LIU MATTIS, Longwood, FL (US); ZHENLIANG HE, Huzhou City, Zhejiang Province (CN)

(21) Appl. No.: 18/557,291

(22) PCT Filed: Apr. 25, 2022
(86) PCT No.: PCT/US2022/026230

§ 371 Date: Oct. 25, 2023

Related U.S. Application Data
(60) Provisional application No. 63/179,531, filed on Apr. 25, 2021.

(51) Int. Cl. H01M 10/0587; H01M 10/04; H01M 10/0567; H01M 10/0568; H01M 10/44; H01M 50/358; H01M 50/609

(52) U.S. Cl. CPC H01M 10/0587; H01M 10/0431; H01M 10/0567; H01M 10/0568; H01M 10/446; H01M 50/358; H01M 50/609

(57) ABSTRACT

A method of preparing an electrochemical device includes: S10: providing a positive electrode sheet, a negative electrode sheet and a diaphragm, winding or laminating the positive electrode sheet, the diaphragm and the negative electrode sheet to form an electrode assembly, encapsulating the electrode assembly to obtain a dry electrochemical device; S20: installing the dry electrochemical device; S30: injecting electrolyte into the dry electrochemical device to obtain an electrochemical device, and performing initial activation to the electrochemical device. Further, an electrochemical device is provided, and the electrochemical device is prepared using the above method.

### CROSS REFERENCE TO RELATED APPLICATION

This application claims priority to U.S. provisional patent application No. 63/179,531, filed on Apr. 25, 2021, which is incorporated herein by reference.

### TECHNICAL FIELD

This application relates to the technical field of batteries, and in particular, to a method of preparing an electrochemical device and an electrochemical device prepared by such method.

### BACKGROUND

With the widespread use of lithium-ion batteries in electric vehicles and energy storage, it has become more important for the development of lithium-ion batteries to address the cost and safety issues of lithium-ion batteries. Moisture is one of the most important factors affecting the quality and safety of lithium-ion batteries in the manufacturing process. In order to ensure the performance of lithium-ion batteries, the moisture must be strictly controlled at various stages of the manufacturing process of the lithium-ion batteries.

### Technical Problem

Usually, the various stages of the lithium-ion battery manufacturing require moisture control by drying or baking, etc. The need for strict moisture control in each process greatly increases the cost of the lithium-ion battery manufacturing, as well as the fixed asset investment in equipment for GWh cell capacity. Moreover, the conventional lithium-ion battery needs to be stored and transported according to dangerous goods because it is injected with an electrolyte before leaving the factory, and the requirements for temperature and humidity are high, which increases the storage and transportation costs and safety risks.

### Technical Solution

It is an object of this application to provide a method of preparing an electrochemical device and an electrochemical device that simplifies the preparation process and reduces the cost of the electrochemical device, and the storage and transportation requirements for the dry electrochemical device are greatly reduced compared to conventional lithium-ion batteries.

An embodiment of this application provides a method of preparing an electrochemical device, and the method includes:
S10: providing a positive electrode sheet, a negative electrode sheet and a diaphragm, winding or laminating the positive electrode sheet, the diaphragm and the negative electrode sheet to form an electrode assembly, encapsulating the electrode assembly to obtain a dry electrochemical device;
S20: installing the dry electrochemical device;
S30: injecting electrolyte into the dry electrochemical device to obtain an electrochemical device; and performing initial activation to the electrochemical device.

The above dry electrochemical device refers to an electrochemical device without electrolyte. The method of preparing electrochemical device provided in this application, compared with the traditional method of preparing lithium-ion secondary batteries, the dry electrochemical device does not require injection of electrolyte before installation and use, which greatly simplifies the preparation process and cost, and the storage and transportation requirements and cost of the dry electrochemical device are also greatly reduced compared with traditional lithium-ion batteries. The manufacturing process of the dry electrochemical device of this application can eliminate the processes of dehumidification, slicing, vacuuming, baking, liquid injection, pre-formation, aging, and volume separation, which greatly reduces the plant and equipment investment and O&M costs. The preparation process of a conventional lithium-ion secondary battery and the preparation process of the dry electrochemical device in this application are respectively shown in FIG. 1 and FIG. 2, wherein FIG. 1 is the preparation process of a conventional lithium-ion secondary battery and FIG. 2 is the preparation process of the dry electrochemical device in this application. The above dry electrochemical device manufacturing process does not require control of environmental humidity and water content in the positive and negative electrode sheets, further reducing equipment investment and manufacturing costs. In addition, the traditional lithium-ion secondary batteries need to be stored and transported as dangerous goods; whereas the dry electrochemical device of this application does not contain electrolyte, and can be stored and transported as ordinary goods, with lower requirements for temperature, humidity, etc., and no special requirements for storage and transport, which obviously reduces storage and transport costs, and also solves the safety problems in the process of storage and transport.

An embodiment of this application provides a method of preparing an electrochemical device, and the method includes:
S10: providing a positive electrode sheet, a negative electrode sheet and a diaphragm, winding or laminating the positive electrode sheet, the diaphragm and the negative electrode sheet to form an electrode assembly, disposing the electrode assembly into a housing, and encapsulating the housing with at least one end cap to obtain a dry electrochemical device, wherein a liquid injection hole and a gas exhaust hole are provided through the at least one end cap to communicate with an interior of the housing;
S20: installing the dry electrochemical device at a position, connecting a liquid injection pipe to the liquid injection hole, and connecting a gas exhaust pipe to the gas exhaust hole;
S30: injecting electrolyte into the dry electrochemical device through the liquid injection pipe wherein gas in the housing or excessive electrolyte is discharged out through the gas exhaust hole, so as to obtain an electrochemical device; and
S40: performing initial activation to the electrochemical device.

Before use, the dry electrochemical device is installed, and then an electrolyte is injected for initial activation (Initiation and Activation).

The above method changes the manufacturing process of conventional lithium-ion batteries, resulting in a significant reduction of safety risks in manufacturing, storage, and transportation due to the absence of electrolyte filling during step S10, i.e., dry electrochemical device manufacturing. After the dry electrochemical device without electrolyte has been transported to the destination the manufactured dry electrochemical device needs to be installed and injected with electrolyte to form the electrochemical device, and the electrochemical device is then initially activated before the electrochemical device is put into use. The electrochemical device can be maintained and repaired during use (e.g., replacing parts, replenishing or replacing electrolyte, adding electrolyte additives (Re-conditioner), and other measures) to extend the service life of the electrochemical device.

In a realizable way, the step S30 specifically includes:
injecting a first electrolyte into the dry electrochemical device and performing a first charging to the dry electrochemical device so as to remove the moisture in the dry electrochemical device, and then discharging out the first electrolyte and reaction by-products;
injecting a second electrolyte into the dry electrochemical device to obtain an electrochemical device and performing a second charging to the electrochemical device so as to complete the activation of the electrochemical device (including the formation of a SEI film on the surface of the electrode assembly), thereby obtaining an activated electrochemical device.

In a realizable way, the dry electrochemical device is charged to 10%-90% SOC by the first charging.

In a realizable way, the dry electrochemical device is charged with a constant current of less than or equal to 0.5C during the first charging process.

In a realizable way, the step S30 specifically includes:
injecting a specific electrolyte into the dry electrochemical device to obtain the electrochemical device, wherein the specific electrolyte is capable of reacting with the water in the dry electrochemical device;
charging the electrochemical device to further remove water from the electrochemical device and complete the activation of the electrochemical device (including formation of a SEI film on the surface of the electrode assembly), thereby obtaining an activated electrochemical device.

In a realizable way, the dry electrochemical device is physically de-watered before the injection of electrolyte into the dry electrochemical device, and then the electrolyte is injected into the dry electrochemical device.

In a realizable way, physically de-watering the dry electrochemical device specifically includes:
baking and/or evacuating the dry electrochemical device to reduce the moisture in the dry electrochemical device (which in this application mainly refers to the moisture in the positive electrode sheet) to less than 600 ppm, or less than 400 ppm, or less than 200 ppm.

In a realizable way, the electrode assembly is a rolled electrode assembly, and the electrode assembly is formed by winding the positive electrode sheet, the diaphragm and the negative electrode sheet.

In a realizable way, the electrode assembly further includes a central tube, and the electrode assembly is formed by winding the positive electrode sheet, the diaphragm and the negative electrode sheet around the central tube.

In a realizable way, the electrode assembly is a laminated electrode assembly, wherein the electrode assembly is formed by laminating the positive electrode sheet, the diaphragm and the negative electrode sheet which are laminated and spaced from each other.

In a realizable way, the process of preparation of the positive electrode sheet, the process of preparation of the negative electrode sheet and/or the process of preparation of the dry electrochemical device are carried out in an ordinary environment without humidity control, or in an environment with a humidity of equal or less than 60% but equal or greater than 1%, or in an environment with a humidity of equal or less than 60% but equal or greater than 10%, or in an environment with a humidity of equal or less than 60% but equal or greater than 30%.

Another embodiment of this application also provides an electrochemical device, and the electrochemical device is prepared using the method described above.

In a realizable way, the electrochemical device is a laminated electrochemical device.

In a realizable way, the electrochemical device is a rolled electrochemical device, the electrochemical device includes a rolled core, a housing and at least one end cap, the rolled core is located in the housing; one end of the housing is provided with an opening, the end cap is provided at the opening of the housing; the end cap is provided with a gas exhaust hole and a liquid injection hole. The gas exhaust hole in this application can also be used to drain a liquid, such as excessive electrolyte, and the liquid injection hole can be used to add a gas, such as an inert gas.

In a realizable way, the housing is provided with openings at two opposite ends, the at least one end cap includes a first end cap and a second end cap, the first end cap and the second end cap are provided at the openings at the two opposite ends of the housing, respectively; the gas exhaust hole and the liquid injection hole are provided in the first end cap and the second end cap respectively, or are both provided in the first end cap or in the second end cap.

In a realizable way, a gas exhaust valve is provided at the gas exhaust hole, and the gas exhaust valve is connected to the gas exhaust hole; and/or, a liquid injection valve is provided at the liquid injection hole, and the liquid injection valve is connected to the liquid injection hole.

In a realizable way, a gas exhaust pipe is provided, the gas exhaust pipe is connected to the gas exhaust hole, and the gas exhaust valve is provided in the gas exhaust pipe; and/or, a liquid injection pipe is provided, the liquid injection pipe is connected to the liquid injection hole, and the liquid injection valve is provided in the liquid injection pipe.

In a realizable way, the number of the electrochemical devices is multiple, the multiple electrochemical devices are provided in series and/or in parallel, and the gas exhaust pipes on the multiple electrochemical devices are connected together; and/or, the liquid injection pipes on the multiple electrochemical devices are connected together.

In a realizable way, the rolled core is provided with a central tube in the center of the rolled core, and the rolled core is formed by winding a positive electrode sheet, a diaphragm and a negative electrode sheet around the central tube.

In a realizable way, the central tube is located inside the housing and two ends of the central tube does not extend to the outside of the housing, and both ends of the central tube are located between the current collecting member on the inside of the first end cap and the current collecting member on the inside of the second end cap.

In a realizable way, the central tube is located inside the housing and the end of the central tube extends to the outside the housing after passing through the end cap.

In a realizable way, the housing is provided with openings at two opposite ends, the at least one end cap includes a first end cap and a second end cap, the first end cap and the second end cap are provided at the openings at opposite ends of the housing; one end of the central tube extends to the outside of the housing after passing through the first end cap and the other end of the central tube extends to the outside of the housing after passing through the second end cap.

In a realizable way, the central tube is provided with a breaking hole, the breaking hole is located within the housing; a sealing material is provided in the breaking hole, and the sealing material seals the breaking hole.

In a realizable way, the sealing material is made of a material with a melting point of 70° C.-150° C.

In a realizable way, the central tube is provided with a temperature sensor.

In a realizable way, the end cap is provided with an electrode terminal (or pole), the electrochemical device further includes a current collecting member, the current collecting member is located in the housing, the current collecting member is electrically connected to both tabs on the rolled core and the electrode terminal (or pole).

In a realizable way, an insulating pad is provided between the electrode terminal (or pole) and the end cap.

In a realizable way, an insulating member is provided between the current collecting member and the end cap.

In a realizable way, the housing is provided with an insulating film, and the insulating film is located between the rolled core and the inner wall of the housing.

### Beneficial Effects

The method of preparing electrochemical device provided in this application, compared with the traditional method of preparing lithium-ion secondary batteries, the dry electrochemical device does not require injection of electrolyte before installation and use, which greatly simplifies the preparation process and cost, and the storage and transportation requirements and cost of the dry electrochemical device are also greatly reduced compared with traditional lithium-ion batteries. The manufacturing process of the dry electrochemical device of this application can eliminate the processes of dehumidification, slicing, vacuuming, baking, liquid injection, pre-formation, aging, and volume separation, which greatly reduces the plant and equipment investment and O&M costs. Moreover, there is no need to control the ambient humidity and the water content in the positive and negative electrode sheets during the manufacturing process of the dry electrochemical device, further reducing the equipment investment and manufacturing cost. In addition, traditional lithium-ion secondary batteries need to be stored and transported as dangerous goods; whereas the dry electrochemical device of this application does not contain electrolyte, and can be stored and transported as ordinary goods, with lower requirements for temperature, humidity, etc., and no special requirements for storage and transportation, significantly reducing storage and transportation costs and solving possible safety problems in the process of storage and transportation.

### BRIEF DESCRIPTION OF THE DRAWINGS

FIG. 1 is a flow chart of the preparation of lithium-ion secondary batteries in the prior art.

FIG. 2 is a flow chart of the preparation of a dry electrochemical device in an embodiment of this application.

FIG. 3 is a schematic diagram of the structure of the electrode sheet in an embodiment of this application.

FIG. 4 is a schematic diagram of the structure of the electrode sheet in another embodiment of this application.

FIG. 5 is a cross-sectional diagram of the electrochemical device in an embodiment of this application.

FIG. 6 is a schematic diagram of the structure of the electrochemical devices connected in parallel in an embodiment of this application.

FIG. 7 is a schematic diagram of the structure of the electrochemical device connected in series in another embodiment of this application.

FIG. 8 shows a cross-sectional diagram of the electrochemical device in another embodiment of this application.

FIG. 9 is a cross-sectional diagram of a cross-section of the electrochemical device in another embodiment of this application.

FIG. 10 is a schematic diagram of the three-dimensional structure of the electrochemical device of FIG. 9.

FIG. 11 is a schematic diagram comparing the charging/discharging tests of embodiments 1-3 and Embodiment 5 of this application with the electrochemical devices of comparative examples 1-2 at room temperature (25° C.).

FIG. 12 is a schematic diagram comparing the charging/discharging tests of embodiments 1-3 and Embodiment 5 of this application with the electrochemical devices of comparative examples 1-2 at high temperature (45° C.).

FIG. 13 is a schematic diagram of the electrochemical device in Embodiment 6 of this application for charging and discharging tests at room temperature.

In the figures, 10—rolled core; 110—electrode sheet; 112—tab; 20—housing; 30—central tube; 310—temperature sensor; 320—breaking hole; 410—first current collecting member; 420—second current collecting member; 510—first electrode terminal; 520—second electrode terminal; 530—first pole; 540—second pole; 610—first end cap; 620—second end cap; 70—liquid injection hole; 80—gas exhaust hole; 910—first insulating member; 920—second insulating member; 930—insulating pad; 940—insulating film; 950—fastener.

### DETAILED DESCRIPTION OF PREFERRED EMBODIMENTS

The specific embodiments of this application are described in further detail below in conjunction with the accompanying drawings and embodiments. The following examples are used to illustrate this application, but are not intended to limit the scope of this application.

The terms “first”, “second”, “third”, “fourth”, and so forth in the specification and claims of this application, if present, are used to distinguish similar objects and need not be used to describe a particular order or sequence.

An embodiment of this application provides a method of preparing an electrochemical device, and the method includes:
S10: providing a positive electrode sheet, a negative electrode sheet and a diaphragm, winding or laminating the positive electrode sheet, the diaphragm and the negative electrode sheet to form an electrode assembly, encapsulating the electrode assembly to obtain a dry electrochemical device;
S20: installing the dry electrochemical device;
S30: injecting electrolyte into the dry electrochemical device to obtain an electrochemical device, and performing initial activation to the electrochemical device so as to obtain an activated electrochemical device.

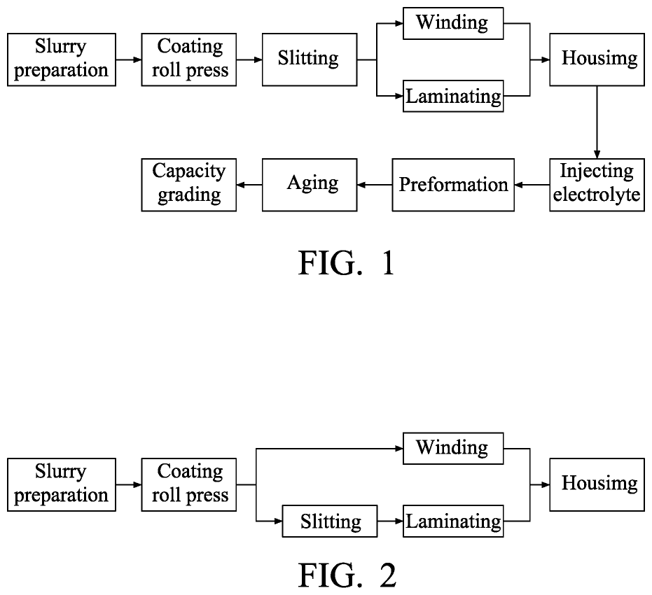

The above dry electrochemical device refers to an electrochemical device without electrolyte. The method of preparing electrochemical device provided in this application, compared with the traditional method of preparing lithium-ion secondary batteries, the dry electrochemical device does not require injection of electrolyte before installation and use, which greatly simplifies the preparation process and cost, and the storage and transportation requirements and cost of the dry electrochemical device are also greatly reduced compared with traditional lithium-ion batteries. The manufacturing process of the dry electrochemical device of this application can eliminate the processes of dehumidification, slicing, evacuation, baking, liquid injection, pre-formation, aging, and volume separation, which greatly reduces the investment in plant and equipment and the cost of operation and maintenance, as well as reduces the security level of the lithium-ion cell manufacturing workshop. The preparation process of a conventional lithium-ion secondary battery and the preparation process of the dry electrochemical device in this application are respectively shown in FIG. 1 and FIG. 2, wherein FIG. 1 is the preparation process diagram of a conventional lithium-ion secondary battery and FIG. 2 is the preparation process diagram of the dry electrochemical device in this application. The above dry electrochemical device is manufactured without controlling or strictly controlling the ambient humidity and the water content in the positive and negative electrode sheets, further reducing the investment in equipment and manufacturing costs. In addition, conventional lithium-ion secondary batteries need to be stored and transported as dangerous goods; whereas the dry electrochemical device of this application does not contain electrolyte and can be stored and transported as ordinary goods, with lower requirements for temperature, humidity, etc., and no special requirements for storage and transport, significantly reducing storage and transport costs.

In step S10 above, the positive electrode sheet and the negative electrode sheet can be made using a method similar to the fabrication of electrode sheets in lithium-ion secondary batteries. The preparation process of the electrode sheet and the preparation of the dry electrochemical device can be carried out under dehumidified dry conditions (e.g., humidity less than 30%) as in the prior art lithium battery preparation methods, or in a normal environment without dehumidification (e.g., humidity of 30%-60%). If the electrode sheet and the dry electrochemical device are prepared in a normal environment, the dehumidification device can be omitted and the energy consumption can be reduced, to further reduce the manufacturing cost. Among them, the positive electrode material can be selected from one or more of lithium cobalt oxide, lithium manganese oxide, lithium iron phosphate, lithium manganese phosphate, lithium manganese iron phosphate, lithium nickel cobalt manganese oxide, lithium nickel cobalt aluminum oxide, lithium nickel manganese oxide, and composite materials obtained by modification or coating of the above materials. It should be noted that if manufactured in a normal environment without dehumidification, the high nickel content cathode material (e.g., NCM811 cathode material) reacts with water causing structural damage and thus loss of electrochemical activity, thus requiring a water-proof treatment during the preparation process.

The negative electrode material can be selected from at least one of graphite, intermediate phase carbon microspheres, amorphous carbon, lithium-titanium oxide compounds, silicon-based materials, tin-based materials, and transition metal oxides; silicon-based materials such as silicon, silicon alloys, silicon carbon complexes, or silicon oxides.

This application does not limit the diaphragm in the dry electrochemical device and can usually be selected according to the requirements of the final prepared electrochemical device or the preparation conditions of step S30. For example, the diaphragm may be selected from one of a polyolefin diaphragm, a polyvinylidene fluoride diaphragm, an aramid diaphragm, a polyamide diaphragm, and a composite diaphragm obtained by coating or laminating the above diaphragms; or the diaphragm is selected from an inorganic solid electrolyte diaphragm; or the diaphragm is selected from an organic solid electrolyte diaphragm; or the diaphragm is selected from a composite diaphragm of an inorganic solid electrolyte and an organic solid electrolyte.

According to the purpose of this application, the structure of the electrode assembly is not limited. The electrode assembly can be a commonly used rolled electrode assembly or a laminated electrode assembly.

As an embodiment, the electrode assembly is a laminated electrode assembly, and the electrode assembly is formed by laminating the positive electrode sheet, the diaphragm and the negative electrode sheet.

In another embodiment, the electrode assembly is a rolled electrode assembly, and the electrode assembly is formed by winding the positive electrode sheet, the diaphragm and the negative electrode sheet. As an embodiment, the electrode assembly further includes a central tube, and the electrode assembly is formed by winding the positive electrode sheet, the diaphragm and the negative electrode sheet around the central tube.

In the case of a rolled electrode assembly, for example, the dry electrochemical device includes a cylindrical rolled core (i.e., rolled electrode assembly), which can be 20-130 cm in length, or 40-110 cm in length, or 60-100 cm in length. The diameter of the rolled core can be 3-60 cm, or 6-30 cm in diameter, or 10-25 cm in diameter. The electrochemical device of this application can obtain a high single cell capacity, the same capacity of the energy storage system requires fewer monomers, and the consistency between monomers is easier to control, which is conducive to improving the working performance of the overall energy storage system, and at the same time, due to the large capacity of a single electrochemical device (e.g., greater than 10 kWh), which in turn simplifies the integration of modules and battery packs in the manufacturing process of conventional battery systems, further reducing manufacturing cost of energy storage systems. In some embodiments, the electrochemical device may have a monolithic capacity of 2-30 kWh, or a capacity of 3-20 kWh, or a capacity of 5-15 kWh, or a capacity of 5-10 kWh.

Specifically, the steps of preparing the rolled core can be: selecting a collector of suitable width, preparing a positive slurry and a negative slurry, coating the positive slurry on the positive collector (e.g., aluminum foil) and coating the negative slurry on the negative collector (e.g., copper foil), and then forming the positive electrode sheet and the negative electrode sheet by roll pressing. The coating width of the electrode sheet matches the length of the rolled core. A portion of the empty foil area is left at one end of the electrode sheet during coating, such as 5-30 mm, or 8-25 mm, or 10-20 mm, as the tab of the rolled core. The tab is welded to the current collecting member and then connected to the electrode terminal. Since the width of the collector has been selected during the above preparation process, the positive and/or negative electrode sheets do not need to be sliced after finishing the coating roll, and can be wound directly with the diaphragm to form a rolled core. In some embodiments, the diaphragm may be hot pressed onto the negative electrode sheet and then wound, or the diaphragm may be hot pressed onto the positive electrode sheet and then wound to form the rolled core. In some embodiments, the positive electrode sheet and/or the negative electrode sheet can also be made using the dry electrode sheet preparation method of the prior art.

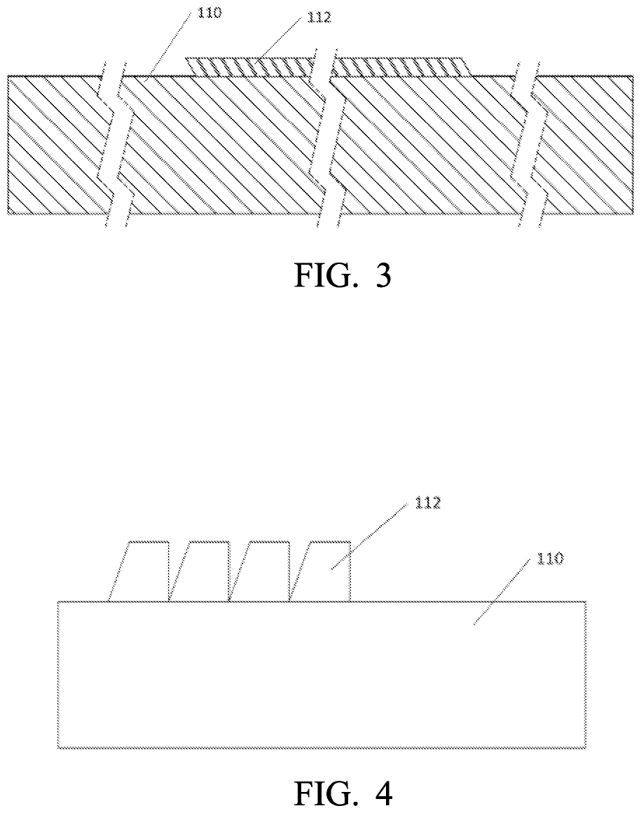

For the setting of the tabs on the electrode sheet (including the positive electrode sheet and the negative electrode sheet), as shown in FIG. 3, as an embodiment, multiple tabs 112 can be formed by cutting the empty foil area on the electrode sheet 110, and the tabs 112 are inclined toward the winding direction of the electrode sheet 110. Such a setting can reduce the pressure required for flattening the tabs 112 during the winding process, making the tabs 112 flatter and easier to weld with the current collecting members, and also reducing the impact of the flattening process on the electrode sheet 110, greatly improving the qualified rate of the rolled core.

As shown in FIG. 4, as an alternative embodiment, multiple tabs 112 can be formed by cutting the empty foil area on the electrode sheet 110, the tabs 112 are inclined toward the winding direction of the electrode sheet 110, and the width of the tabs 112 decreasing gradually along the direction away from the electrode sheet 110. The above design helps to improve the flatness of the tabs 112 after flattening, thus improving the stability of the tabs 112 and the welding of the current collecting members.

As an embodiment, the center of the rolled core is provided with a central tube, and the central tube can be a high temperature resistant plastic tube, or a high temperature resistant plastic tube lined with a metal tube. The central tube can be used as a spool in the winding process of the rolled core, and the central tube is provided with the end cap sealed. In use, a coolant or high temperature fluid can be passed into the central tube to regulate the temperature of the electrochemical device; the central tube can also be used as a channel to pass coolant and/or fire suppressant into the electrochemical device in the event of thermal runaway of the electrochemical device. For example, multiple breaking holes are provided in the wall of the central tube, and the plurality of breaking holes are sealed with a low melting point sealing material (e.g., low melting point plastic). When the temperature of the electrochemical device rises rapidly due to thermal runaway, the low melting point sealing material softens and breaks to open, and at this moment, the coolant in the central tube is injected into the interior of the electrochemical device for cooling, while the coolant dilutes the electrolyte, thus stopping the thermal runaway from spreading and stalling the accident.

After the above rolled core preparation is completed, the tabs of the rolled core are welded to the current collecting members and then mounted into the housing, and the end caps are installed to form the dry electrochemical device. The housing is a cylindrical housing with the end caps mounted at both ends thereof. The central tube passes through the end caps, and is insulated from and sealed with the end caps. In an alternative embodiment, the central tube acts only as a spool and the central tube is located between the current collecting members at the two end caps, and the central tube does not pass through the end caps. The housing can be a plastic housing or a metal housing, and the end cap is made of plastic or metal, with a liquid injection hole and a gas exhaust hole provided in the end cap. In some embodiments, the material of the housing can be selected from at least one of PP, PE, PVDF, PTFE, PEEK, and polysulfone.

Compared with conventional lithium-ion secondary battery preparation methods, the dry electrochemical device is not filled with electrolyte, and the environmental humidity and the water content in the positive and negative electrode sheets can be uncontrolled or not strictly controlled during the preparation process, for example, the electrode sheets can be coated with a lower cost aqueous slurry, and the prepared electrode sheets and the rolled cores do not need to be dried and de-watered. The prepared dry electrochemical device has low requirements for temperature, humidity, etc., and no special requirements for storage and transportation, which significantly reduces storage and transportation costs and improves safety.

Since there is no need to control moisture during the preparation of the dry electrochemical device, the water content requirements in the materials such as positive electrode sheet, negative electrode sheet, diaphragm, conductive additives, and adhesives are also lower, reducing the cost of the materials during production, storage, and use. Moreover, in step S10, i.e., the manufacturing process of the dry electrochemical device can eliminate the processes of dehumidification, slitting, evacuation, baking, liquid injection, pre-formation, aging, and volume separation, which greatly reduces the manufacturing cost. The whole dry electrochemical device manufacturing plant can be without dehumidification system, which greatly reduces the cost of plant and equipment investment and operation and maintenance.

The resulting dry electrochemical device can be filled with an inert gas, e.g., through the gas exhaust hole or the liquid injection hole, and then the valve connected to the gas exhaust hole or the liquid injection hole is closed. By filling with an inert gas, the dry electrochemical device can be prevented from absorbing further moisture during storage and transport, or from being affected by other gases in the environment.

Before use, according to steps S20 and S30, the dry electrochemical device is first installed, and then an electrolyte is added for initial activation (Initiation and Activation) to obtain an electrochemical device.

In step S20, installing the dry electrochemical device includes: fixing the dry electrochemical device at a position, and connecting the gas exhaust pipe and/or the liquid injection pipe. The gas exhaust pipe is connected to the gas exhaust hole on the electrochemical device, and the liquid injection pipe is connected to the liquid injection hole on the electrochemical device. Step S20 can be completed at the manufacturing plant of the dry electrochemical device or at the use place of the electrochemical device. That is, the dry electrochemical device can be assembled into a cluster and then stored or transported, or the dry electrochemical device can be transported to the use place and then installed (assembled).

The initial activation is a new process in the manufacturing process of this electrochemical device, and its main roles are water removal (for the scenario where moisture control is not performed in the manufacturing process of the dry electrochemical device) and activation. The initial activation is an important step in this electrochemical device preparation method. Unlike the pre-formation step in the ordinary lithium-ion battery manufacturing method, the initial activation process in this application is intended to remove water from the electrochemical device on the one hand, and to complete the activation of the electrochemical device (including the generation of SEI film) at the same time. Conventional lithium-ion batteries may also remove a small amount of water during the pre-formation process, but there is a clear difference from the initial activation process of this application because the water content of the battery cells is strictly controlled during their pre-formation manufacturing process.

As an embodiment, the initial activation can be divided into two steps: (1) injecting a first electrolyte into the dry electrochemical device and performing a first charging to the dry electrochemical device at room temperature or high temperature, so as to remove the water in the dry electrochemical device, and then discharging out the first electrolyte and reaction by-products, wherein the first electrolyte does not contain a lithium salt that easily reacts with water, and the lithium salt that easily reacts with water may be such as lithium hexafluorophosphate; (2) injecting a second electrolyte into the dry electrochemical device to obtain an electrochemical device and performing a second charging to the electrochemical device, so as to complete the activation of the electrochemical device, thereby obtaining an activated electrochemical device. After the activation is completed, the valve on the electrochemical device is closed to seal the electrochemical device, allowing the second electrolyte to be retained within the electrochemical device. The gas generated by the activation process can be discharged out through the gas exhaust hole.

Specifically, the main purpose of the first charging in step (1) is to remove the water from the dry electrochemical device. The by-products generated in step (1) can be precipitated out using a solvent or driven out by the injected second electrolyte, thus reducing impact on the performance of the electrochemical device. In some implementations, the first charging in step (1) can be performed at different temperatures depending on the battery design (e.g., different adhesives and diaphragms), thus increasing efficiency and reducing time. For example, the electrochemical device uses an aramid diaphragm, and the first charging can be performed above 40° C., or above 60° C., or above 80° C., or above 100° C. With other diaphragms, the first charging can be performed at a higher temperature, such as 40° C.-80° C., depending on the diaphragm material of choice.

In one embodiment, the first electrolyte does not include a lithium salt that readily reacts with water, and the lithium salt that readily reacts with water includes lithium hexafluorophosphate. The component of the first electrolyte includes at least one lithium salt selected from LiTFSI, LiFSI and lithium perchlorate.

The above second electrolyte can be an electrolyte usually used in the field of lithium-ion batteries in the prior art, without limitation.

The main purpose of the second charging in step (2) is to activate the electrochemical device. The process includes the formation of a stable SEI film on the surface of the electrode.

The first charging in step (1) is done when the dry electrochemical device is charged to 10%-90% SOC, or to 20%-70% SOC, or to 20%-50% SOC, or to 10%-30% SOC. Charging is carried out during the first charging at a constant current of less than or equal to 0.5C, or less than or equal to 0.3C, or 0.02-0.2C, or 0.02-0.1C, or 0.05-0.2C.

As another implementation, the initial activation can be done in one step as such: a specific electrolyte (which is capable of reacting with the moisture in the dry electrochemical device) is injected into the dry electrochemical device to obtain the electrochemical device; then the electrochemical device is charged to complete the activation of the electrochemical device, thereby obtaining the activated electrochemical device. In the process, at least part of the water or most of the water will be removed by the reaction, in addition to the formation of SEI film on the electrode surface, that is, the water removal and the activation of the electrochemical device are completed in the same process.

As an embodiment, the above specific electrolyte contains an additive A that can react with water, and the water can be removed by the reaction before charging. The by-products generated after the reaction of the additive A with the water do not affect the performance of the electrochemical device, and the water or gaseous by-products (if any) can be removed in the initial activation system.

In some embodiments, the additive A includes at least one of the following compounds: 1) anhydrides, such as propionic anhydride, maleic anhydride and sulfonic anhydride, etc.; 2) silazanes, such as hexamethyldisilazane (HMDS), heptamethyldisilazane (H7DMS), etc.; 3) isocyanates, such as TMSNCO and PTSI, etc.; 4) imines, such as cyclohexyl carbodiimide (DCC), N, N-diisopropylcarbodiimide, etc.

The above specific electrolyte also contains a solvent and a lithium salt, the solvent and the lithium salt can be a solvent or a lithium salt commonly used in the field of lithium-ion batteries in the prior art, without limitation.

Since the electrolyte needs to be injected into the dry electrochemical device during the initial activation in step S30, and the moisture and possible gas generated are discharged out from the electrochemical device, a gas exhaust hole and a liquid injection hole are therefore provided in the electrochemical device.

Since no electrolyte is filled during step S10, i.e., during the dry electrochemical device fabrication, the safety risks in fabrication, storage and transportation of electrochemical devices are greatly reduced. At the same time, the existing lithium battery preparation method usually needs to control the ambient humidity less than or equal to 2%, or control the ambient humidity less than or equal to 1%; while the preparation method of this application does not need to control the ambient humidity, or only needs to control the ambient humidity less than or equal to 60%, or less than or equal to 30%, or less than or equal to 10%. In step S30, the moisture in the dry electrochemical device is reduced to an acceptable amount by adding the electrolyte once or twice, and then the electrochemical device is made, which can eliminate the dehumidification device and can reduce the energy consumption, which helps to reduce the manufacturing cost.

In an alternative embodiment, in step S30, the dry electrochemical device is physically de-watered before the electrolyte is injected into the dry electrochemical device for initial activation.

As an embodiment, physically de-watering the dry electrochemical device specifically includes:

The dry electrochemical device is baked and/or evacuated to reduce the moisture in the dry electrochemical device (indicated and tested in this application mainly by the moisture in the positive electrode sheet) to less than 600 ppm, or to less than 400 ppm, or to less than 200 ppm, or to less than 100 ppm, and then the electrolyte is filled for activation to form the electrochemical device. It has been experimentally demonstrated that when the moisture in the dry electrochemical device is reduced to less than 200 ppm by physical means, the electrolyte commonly used in the prior art can be injected into this dry electrochemical device, and after activation, the performance of the lithium-ion battery can eventually be obtained substantially equivalent to that of the prior art as well. Only, it takes longer time or higher energy consumption to reduce the moisture to less than 200 ppm or to less than 100 ppm by physical methods.

As an embodiment, the above-mentioned scheme of physical water removal can be used alone, such as reducing the water inside the dry electrochemical device to less than 400 ppm or to less than 200 ppm by the physical water removal method, and then refilling with a common electrolyte to obtain the electrochemical device.

As another embodiment, the above-mentioned scheme of physical water removal can also be used in combination, such as physically removing water from a dry electrochemical device first (e.g., reducing it to less than 800 ppm, or reducing it to less than 600 ppm), and then obtaining an electrochemical device by a scheme of adding a first electrolyte and a second electrolyte.

As another embodiment, the above-mentioned methods of physical water removal can also be used in combination, such as physically removing water from a dry electrochemical device first (e.g., reducing it to less than 800 ppm, or reducing it to less than 600 ppm), and then obtaining an electrochemical device by a scheme of adding a specific electrolyte.

Embodiments of this application also provide an electrochemical device, which is prepared using the method of preparing the electrochemical device described above.

As an embodiment, the electrochemical device is a laminated electrochemical device.

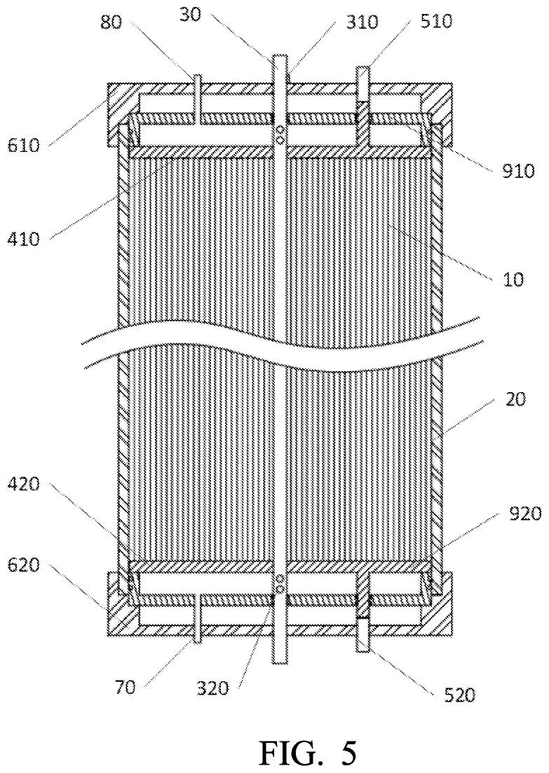

As an alternative embodiment, as shown in FIG. 5, the electrochemical device is a rolled electrochemical device, the electrochemical device includes a rolled core 10 (i.e., a rolled electrode assembly), a housing 20 and an end cap, the rolled core 10 is disposed in the housing 20; an opening is provided at the end of the housing 20, and the end cap is provided at the opening of the housing 20.

As shown in FIG. 5, as an embodiment, the housing 20 is provided with openings at opposite ends, and the end caps include a first end cap 610 and a second end cap 620, with the first end cap 610 and the second end cap 620 provided at the openings at opposite ends of the housing 20, respectively.

As shown in FIG. 5, as an embodiment, the end cap is provided with an electrode terminal, one end of which is located inside the housing 20 and the other end extends outside the housing 20 after passing through the end cap. The electrochemical device also includes a current collecting member, the current collecting member is located within the housing 20, and the current collecting member is electrically connected to both the tab and the electrode terminal on the rolled core 10.

Specifically, the electrode terminals include a first electrode terminal 510 and a second electrode terminal 520, the first electrode terminal 510 is provided on the first end cap 610 and the second electrode terminal 520 is provided on the second end cap 620. The current collecting member includes the first current collecting member 410 and the second current collecting member 420, and the pole ear of one end of the rolled core 10 is welded to the first current collecting member 410, and the first current collecting member 410 is then electrically connected to the first electrode terminal 510; the pole ear of the other end of the rolled core 10 is welded to the second current collecting member 420, and the second current collecting member 420 is then electrically connected to the second electrode terminal 520, so as to realize the electrical connection between the rolled core 10 and the first electrode terminal 510 and the second electrode terminal 520.

As shown in FIG. 5, as an embodiment, an insulating member is provided between the current collecting member and the end cap, and the end cap and/or insulating member is hermetically connected to the housing 20.

Specifically, the insulating member includes a first insulating member 910 and a second insulating member 920, the first insulating member 910 is provided between the first current collecting member 410 and the first end cap 610, and the second insulating member 920 is provided between the second current collecting member 420 and the second end cap 620.

As shown in FIG. 5, as an embodiment, at least one end cap is provided with a liquid injection hole 70 through which electrolyte is added to the dry electrochemical device (inside the housing 20). For example, in FIG. 5, a liquid injection hole 70 is provided in the second end cap 620, through which electrolyte can be injected into the dry electrochemical device for initial activation, or the electrolyte can be replenished as needed during the use of the electrochemical device, or replaced with a new electrolyte of different components, or electrolyte additives can also be added to significantly extend the service life of the electrochemical device. A liquid injection valve (not shown) may be provided at the liquid injection hole 70, which is connected to the liquid injection hole 70 and closed after completion of the liquid injection (the liquid injection valve is, for example, a one-way valve controlling the flow of electrolyte from the outside to the inside of the cell). In some embodiments, a liquid injection pipe (not shown) is provided at the liquid injection hole 70, the liquid injection pipe is connected to the liquid injection hole 70, and the liquid injection valve is provided in the liquid injection pipe.

As shown in FIG. 5, as an embodiment, at least one end cap is provided with a gas exhaust hole 80, with a gas exhaust valve at the gas exhaust hole 80 (not shown, the gas exhaust valve may be a one-way valve controlling the flow of gas and/or liquid from the inside of the battery to the outside), and the gas exhaust valve is connected to the gas exhaust hole 80. For example, in FIG. 5, a gas exhaust hole 80 is provided in the first end cap 610. Moisture in the dry electrochemical device and other gases generated during the initial activation process can be exhausted through the gas exhaust hole 80, and gases generated during the use of the electrochemical device can also be exhausted through the gas exhaust hole 80. In some embodiments, excess electrolyte in the electrochemical device can also be discharged through the gas exhaust hole 80. In some embodiments, a gas exhaust pipe (not shown) may be provided at the gas exhaust hole 80, the gas exhaust pipe is connected to the gas exhaust hole 80, and a gas exhaust valve is provided in the gas exhaust pipe.

As an implementation, the liquid injection hole 70 and the gas exhaust hole 80 can be provided in the same end cap or in two opposite end caps respectively (i.e., the gas exhaust hole 80 and the liquid injection hole 70 can be provided in the first end cap 610 or in the second end cap 620 at the same time, or in the first end cap 610 and the second end cap 620 respectively). In some embodiments, depending on the actual installation of the electrochemical device, the liquid injection hole 70 and the gas exhaust hole 80 may be interchangeable, i.e., the liquid injection hole 70 may serve as the gas exhaust hole 80 and the gas exhaust hole 80 may serve as the liquid injection hole 70. In some embodiments, the liquid injection hole 70 is provided in the lower end cap of the electrochemical device and the gas exhaust hole 80 is provided in the upper end cap of the electrochemical device. In addition, the gas exhaust hole 80 can also be used to discharge excess electrolyte.

As shown in FIG. 5, as an implementation, the center of the rolled core 10 is provided with a central tube 30, and the rolled core 10 is formed by winding the positive electrode sheet, the diaphragm and the negative electrode sheet around the central tube 30, i.e., the central tube 30 can act as a spool during the winding of the rolled core 10. The central tube 30 may be a high temperature resistant plastic tube, or a high temperature resistant plastic tube lined with a metal tube. During use of the electrochemical device, a cooling solution may be passed into the central tube 30 for performing temperature regulation to the electrochemical device, such as heat dissipation or heating.

As shown in FIG. 5, as one embodiment, the central tube 30 is disposed within the housing 20 and the end of the central tube 30 extends outside of the housing 20 after passing through the end cap. Specifically, one end of the central tube 30 extends outside of the housing 20 after passing through the first end cap 610, and the other end of the central tube 30 extends outside of the housing 20 after passing through the second end cap 620, and the central tube 30 is hermetically connected to the first end cap 610 and the second end cap 620.

As shown in FIG. 5, as an embodiment, the central tube 30 is provided with a breaking hole 320, which is located inside the housing 20; the breaking hole 320 is provided with a sealing material (not shown), and the sealing material is made of a material with a melting point of 70° C.-150° C. The sealing material seals this breaking hole 320. Alternatively, the sealing material is made of a material with a melting point of 80-120° C. For example, in FIG. 5, the central tube 30 is provided with multiple breaking holes 320 in the wall of the tube between the end caps (including the first end cap 610 and the second end cap 620) and the rolled core 10. Multiple breaking holes 320 may be sealed with a low melting point plastic, which softly breaks open when the electrochemical device undergoes thermal runaway resulting in a rapid temperature increase (e.g., up to 150 degrees), at which time the coolant entering the interior of the electrochemical device from the central tube 30 may act as a coolant and fire extinguishing agent to reduce the temperature inside the electrochemical device; the coolant may also dilute the electrolyte and drive it out of the gas exhaust hole 80 electrolyte to disable the cell, thus stopping the spread of thermal runaway and stalling the accident.

As shown in FIG. 5, as an embodiment, the central tube 30 is provided with a temperature sensor 310, which is located outside the housing 20 and set close to the end caps. A temperature sensor 310 is used to detect the temperature of the coolant and/or the interior of the electrochemical device within the central tube 30, thereby facilitating temperature regulation of the electrochemical device.

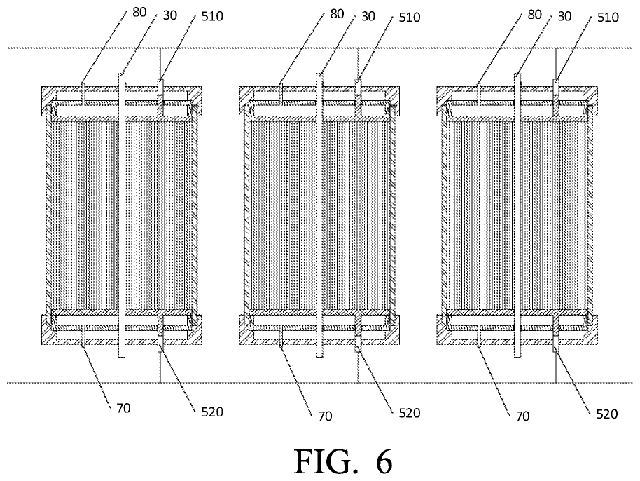

The above electrochemical devices can be connected in series and/or parallel to form an energy storage system. As shown in FIG. 6, as one embodiment, multiple electrochemical devices are vertically disposed and formed into an energy storage system by parallel connection, with a first electrode terminal 510 of each electrochemical device electrically connected and a second electrode terminal 520 of each electrochemical device electrically connected. The gas exhaust hole 80 of each electrochemical device is provided in the upper end cap of such electrochemical device, and a gas exhaust pipe is provided at the gas exhaust hole 80 of each electrochemical device, and a gas exhaust valve is provided in the gas exhaust pipe. The liquid injection hole 70 of each electrochemical device is provided in the lower end cap of the electrochemical device, and a liquid injection pipe is provided at the liquid injection hole 70 of each electrochemical device, and a liquid injection valve is provided in the liquid injection pipe. In some embodiments, the gas exhaust pipes on the above plurality of electrochemical devices can also be connected together, while the liquid injection pipes on the above plurality of electrochemical devices can be connected together to facilitate uniform liquid injection.

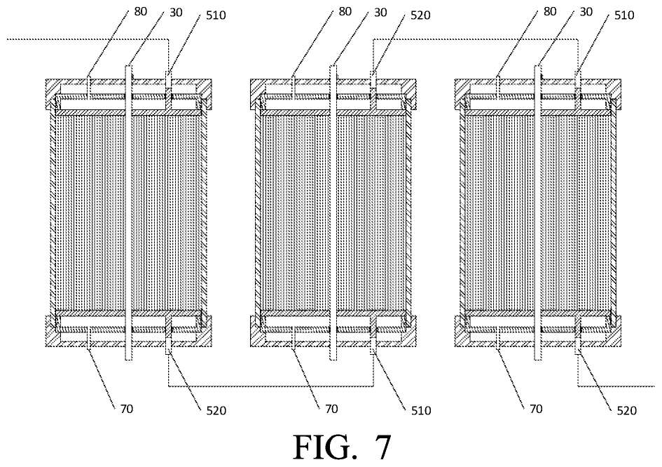

As shown in FIG. 7, as another embodiment, multiple electrochemical devices are vertically arranged and connected in series to form an energy storage system, and the first electrode terminal 510 of one electrochemical device is electrically connected with the second electrode terminal 520 of another electrochemical device.

Whether multiple electrochemical devices are connected in parallel or in series to form an energy storage system, the central tube 30 of each electrochemical device can be connected in series and/or parallel (not shown) so that the coolant is circulated throughout the energy storage system.

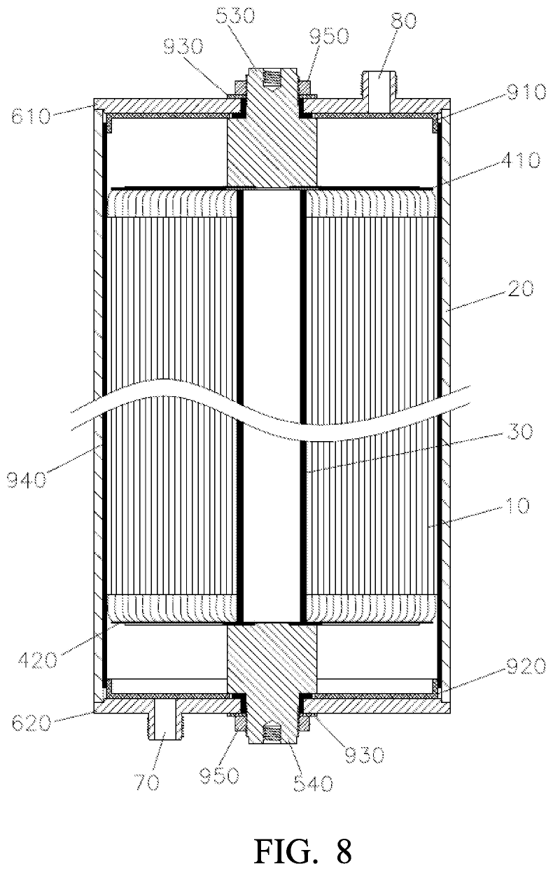

As shown in FIG. 8, as an alternative embodiment, the central tube 30 is located inside the housing 20 and two ends of the central tube 30 does not extend to the outside of the housing 20, i.e., both ends of the central tube 30 are located between the first end cap 610 and the second end cap 620, when the central tube 30 only acts as a spool during the winding of the rolled core 10.

As shown in FIG. 8, as one embodiment, a pole is provided on the end cap, one end of the pole is located within the housing 20 and the other end extends through the end cap to the outside of the housing 20. The poles are secured to the end caps by fasteners 950 (fasteners 950 may be nuts, for example). The electrochemical device also includes a current collecting member, which is located in the housing 20, and the current collecting member is electrically connected to both the tab and the pole on the rolled core 10.

Specifically, the poles include a first pole 530 and a second pole 540, the first pole 530 is provided on the first end cap 610 and the second pole 540 is provided on the second end cap 620. The current collecting member includes a first current collecting member 410 and a second current collecting member 420, and the tab at one end of the rolled core 10 is welded to the first current collecting member 410, and the first current collecting member 410 is then electrically connected to the first pole 530; the tab at the other end of the rolled core 10 is welded to the second current collecting member 420, and the second current collecting member 420 is then electrically connected to the second pole 540, thus realizing the electrical connection between the rolled core 10 and the first pole 530 and the second pole 540.

As shown in FIG. 8, as an implementation, the housing 20 and the end cap are made of metal material, an insulating pad 930 is provided between the poles and the end cap (an insulating pad 930 is provided between the first pole 530 and the first end cap 610 and between the second pole 540 and the second end cap 620), an insulating member is provided between the current collecting member and the end cap (the first insulating member 910 is provided between the first current collecting member 410 and the first end cap 610, and the second insulating member 920 is provided between the second current collecting member 420 and the second end cap 620). Meanwhile, the housing 20 is provided with an insulating film 940, which is provided on the inner wall of the housing 20, and the insulating film 940 is located between the rolled core 10 and the inner wall of the housing 20 to provide insulation.

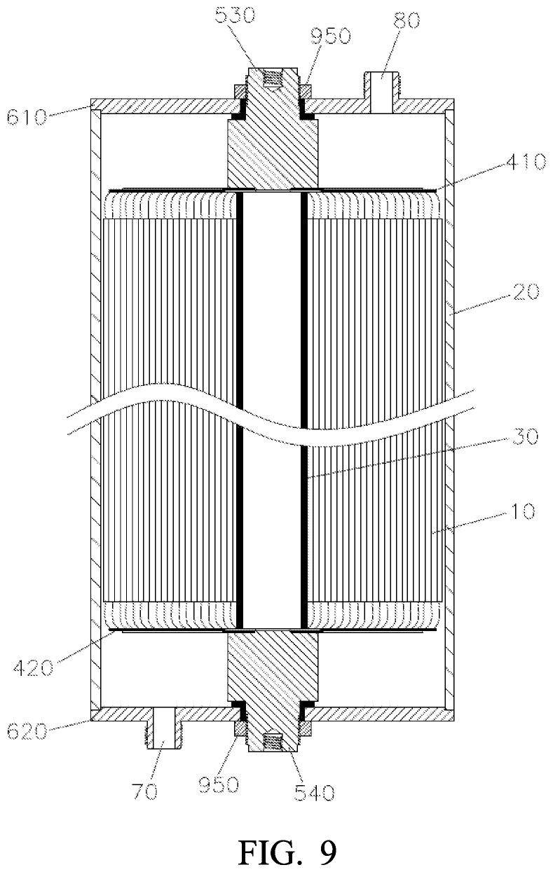

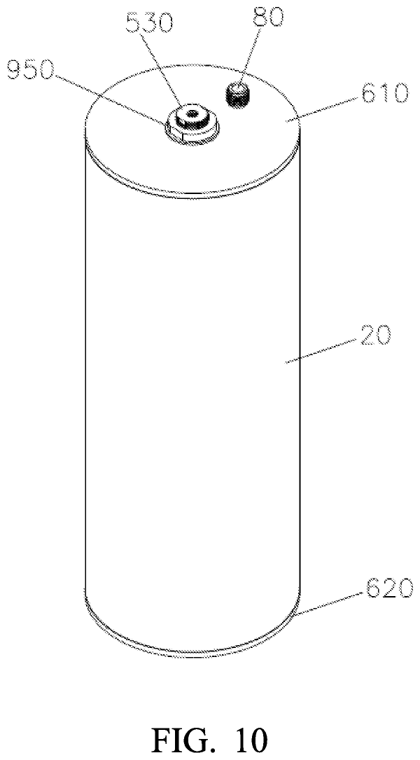

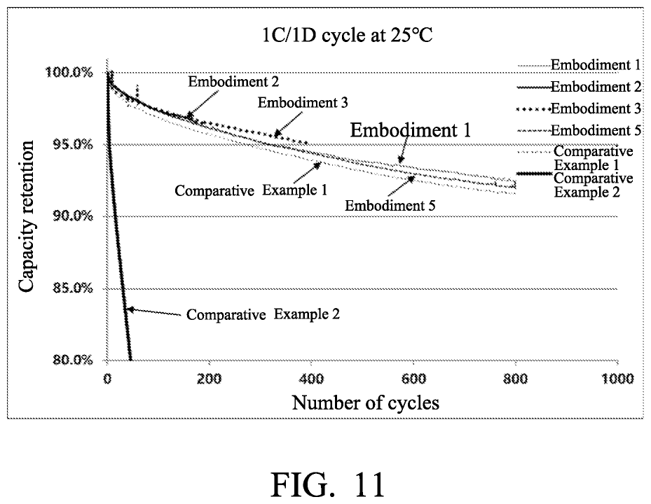

As shown in FIG. 9, as an alternative embodiment, both the housing 20 and the end caps are made of insulating material (e.g., plastic), at which point the insulating pad 930, insulating member, and insulating film 940 may be eliminated.

The electrochemical device of this application is very easy to maintain and repair during use, and can guarantee a longer service life of the electrochemical device, which can be used in the field of energy storage, such as energy storage power plants. Electrochemical devices used in the field of energy storage usually require low charging/discharging rate (usually charge rate is not higher than 1C, or not higher than 0.5C, such as 0.2C; discharge rate is not higher than 0.5C, or discharge rate is not higher than 0.3C, such as 0.1C), while the life expectancy is relatively high. The main deterioration of the electrochemical device after a long period of use is in the electrolyte, and the structure of the electrochemical device of this application facilitates electrolyte replenishment, and the performance of the electrochemical device can be significantly extended by replenishing or replacing the electrolyte after the performance of the electrochemical device decreases, for example, the service life can reach more than 15 years, or the service life can reach more than 20 years, or the service life can reach more than 25 years. In addition, different electrolytes can be injected into the electrochemical device according to different usage requirements and usage environments to significantly improve the adaptability of the electrochemical device, for example, different electrolytes can be used depending on the temperature of the usage environment, thus eliminating the need to require a battery temperature operating condition of −30° C. to +60° C. as in the case of conventional batteries, reducing the demanding requirements for electrolyte performance, further reducing costs and extending life time. For example, the working temperature range of electrochemical device can be set from −30° C. to +40° C. in cold region, from −10° C. to +50° C. in temperate region, and from 0° C. to +60° ° C. in tropical region.

At the same time, the manufacturing method of this application simplifies the manufacturing process of the electrochemical device, greatly reduces the investment in production equipment and sites, and thus can greatly reduce the manufacturing cost of the electrochemical device. Since no electrolyte is used in the manufacturing process, the safety risks in the production process are significantly reduced. Moreover, the packaging and transportation requirements of the product are significantly reduced, which is conducive to reducing transportation costs (ordinary lithium-ion batteries are dangerous goods with high requirements for storage and transportation). On the other hand, the electrochemical device can achieve a very high capacity and it will be easier to control the consistency between products. Compared with conventional secondary batteries, the electrochemical device of this application is easy to maintain and repair during use, such as replacing electrolyte, so that a longer service life can be obtained.

These examples should not be construed as limiting the scope of protection claimed in this application.

### Embodiment 1

Preparation of positive electrode sheet: The positive electrode slurry is made by adding lithium iron phosphate, conductive carbon black and polyvinylidene fluoride to NMP (N-methylpyrrolidone) solvent in the ratio of 96:2:2 by weight, then the positive electrode slurry is coated onto aluminum foil with a thickness of 12 μm, and the positive electrode sheet is made by the process of laminating and slitting.

Preparation of negative electrode sheet: Artificial graphite, polyvinylidene fluoride and conductive carbon black are added to deionized water in the ratio of 94:2:4 by mass of solids and mixed with stirring to make negative electrode slurry, then the negative electrode slurry is coated onto copper foil of 8 μm thickness and made into negative electrode sheet after laminating and slitting.

The positive and negative electrode sheets are not baked and are directly laminated with the diaphragm to form a bare core and encapsulated with aluminum plastic film. The ambient humidity is about 60% throughout the preparation process. Then the cells were baked at 85° C. for 4 h, and the moisture content of the positive electrode was tested by Karl-fisher method, and the moisture content was 580 ppm (1300 ppm before baking). The electrolyte of lithium hexafluorophosphate with a concentration of 1 mol/L and solvents of EC, EMC and DEC (the ratio of EC:EMC:DEC is 1:1:1) is injected into the battery, and the electrolyte is pre-sealed after injection to prevent the electrolyte from contacting with the external environment.

After pre-sealing, the battery is left to stand at 45° C. for 48 h and then pre-formation is performed as follows: Pre-formation temperature 45° C., 0.05C charged for 1 h, 0.1C charged for 1 h, then 0.2C constant current and constant voltage charged to 3.65V. After pre-formation it is set aside at 45° C. for 24 h and then vacuum sealed.

The cells are tested for cycling, and the charging and discharging methods are: 1C constant current and constant voltage charging to 3.65V with a cut-off current of 0.1C, and 1C discharging to 2.5V after standing for 5 min.

### Embodiment 2

The main difference between Embodiment 2 and Embodiment 1 is that 0.5% HMDS (hexamethyldisilazane) is also added to the electrolyte, otherwise it is identical to Embodiment 1.

### Embodiment 3

The main difference between Embodiment 3 and Embodiment 1 is that 0.5% TMSNCO (trimethylsilane isocyanate) is also added to the electrolyte, otherwise it is exactly the same as Embodiment 1.

### Embodiment 4

Embodiment 4 differs from Embodiment 1 mainly in that 0.5% PTSI (p-toluenesulfonic acid isocyanate) is also added to the electrolyte, but is otherwise identical to Embodiment 1.

### Embodiment 5

The difference between Embodiment 5 and Embodiment 1 is mainly that the core is baked at 85° C. for 12 h before liquid injection, otherwise it is exactly the same as Embodiment 1.

### Comparative Example 1

The main differences between Comparative Example 1 and Embodiment 1 are: Comparative Example 1 has environmental humidity control for the main production process of the cells, while both positive and negative electrode sheets are baked at 100° C. for 12 h before laminating, and the cells are baked at 85° C. for 12 h before liquid injection, and the moisture content of positive electrode sheets is 150 ppm before liquid injection. Other than that, it is the same as Embodiment 1. The specific humidity control requirements of each process are: The environmental humidity of batching, coating, laminating and slitting is controlled below 10% relative humidity, the relative humidity of the laminating process is below 1%, the environmental dew point of the liquid injection section is controlled below −45° C., and the other processes are normal temperature and humidity.

### Comparative Example 2

The difference between Comparative Example 2 and Embodiment 1 is that the cores are directly injected with liquid after laminating without baking, and the rest is the same as Embodiment 1. The moisture content of the positive electrode sheet before liquid injection is 1300 ppm.

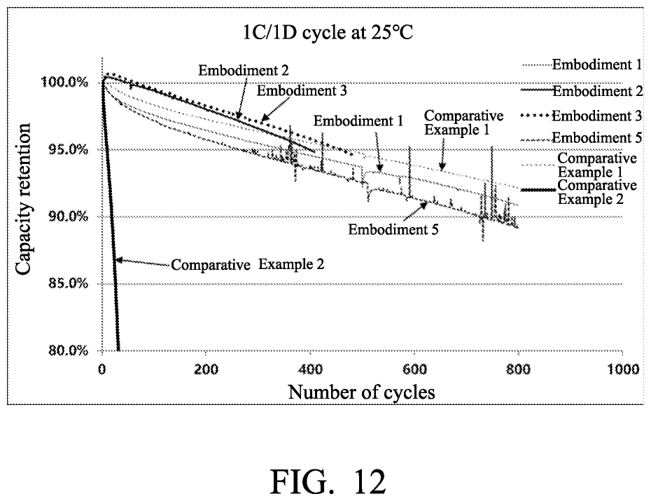

FIG. 11 shows a schematic diagram comparing each embodiment of this application with the comparative example electrochemical device for cyclic charging/discharging testing at room temperature (25° C.), and FIG. 12 shows a schematic diagram comparing each embodiment of this application with comparative example electrochemical device for cyclic charging/discharging testing at high temperature (45° C.). As shown in FIG. 11 and FIG. 12, the normal and high temperature cycling performance of Comparative Example 2 with no control of ambient humidity and no baking is extremely poor, and its capacity decays to less than 80% in less than 100 charging/discharging cycles. If we don't control the environmental humidity, the cycle performance of Embodiment 1 and Embodiment 5, which control the moisture content of the positive electrode sheet to 580 ppm and 400 ppm respectively before liquid injection, is equivalent to that of Comparative Example 1, which strictly controls the environmental humidity and bakes the electrode sheet and battery cell. The cycle performance of Embodiment 2 and Embodiment 3 with the addition of additives is further improved relative to the cycle performance of Embodiment 1 and Embodiment 5.

### Embodiment 6

Preparation of electrode sheet: Lithium iron phosphate, conductive carbon black, binder in the ratio of 94:2:4 in the solvent N-methylpyrrolidone (NMP) mixed into a slurry, according to 30 mg/cm2 surface density coated on the front and back of the aluminum foil, made of positive electrode sheet; graphite, conductive carbon black, binder in the ratio of 92:3:5 in the solvent N-methylpyrrolidone (NMP) mixed into a slurry, according to 15.5 mg/cm2 surface density coated on the front and back side of the copper foil to make negative electrode sheet; dry electrochemical device preparation: Positive electrode sheet, negative electrode sheet and diaphragm by laminating to make soft package core, the whole preparation process is carried out in ordinary environment. The moisture content of the positive and negative electrode sheets was tested to be 929 ppm and 94 ppm, respectively.

The cores are first injected into an electrolyte containing 1M concentration LiTFSI with a solvent of EC: EMC=1:2, set aside for 24 h, and charged with a current of 0.02C to 3.0V to remove the water from the electrode sheet. The aluminum-plastic film of the soft pack cell was opened and immersed in DMC to clean the electrolyte, dried at low temperature (about 45° C.) to remove the DMC, and the moisture content of the positive and negative electrode sheets of one of the cells was tested at 166 ppm and 34 ppm, respectively.

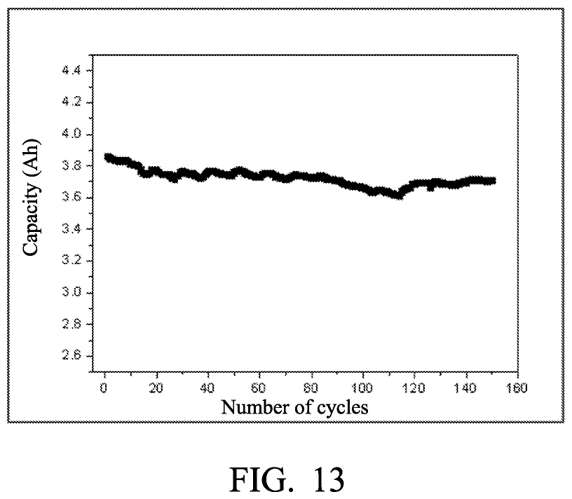

The cleaned cells are dried, and the dried cells are injected with electrolyte containing 1M concentration of LiPF6 with a solvent of EC: EMC=1:2 and set aside for 24 h. Charging to 3.60V and discharging to 2.7V according to the pre-formation procedure. The battery is tested at a 1C multiplier for ambient charging and discharging with 96% of the initial discharging capacity remaining after 150 weeks of cycling (FIG. 13).

The above mentioned is only a specific implementation of this application, but the scope of protection of this application is not limited to this, and any variation or replacement that can be easily thought of by any person skilled in the art within the technical scope disclosed in this application shall be covered by the scope of protection of this application. Therefore, the scope of protection of this application shall be subject to the scope of protection of the stated claims.

1. A method of preparing an electrochemical device, comprising:
S10: providing a positive electrode sheet, a negative electrode sheet and a diaphragm, winding or laminating the positive electrode sheet, the diaphragm and the negative electrode sheet to form an electrode assembly, encapsulating the electrode assembly to obtain a dry electrochemical device;
S20: installing the dry electrochemical device;
S30: injecting electrolyte into the dry electrochemical device to obtain an electrochemical device, and performing initial activation to the electrochemical device.

2. The method according to claim 1, wherein a process of preparing the positive electrode sheet, a process of preparing the negative electrode sheet and/or a process of preparing the dry electrochemical device is carried out in an environment without humidity control, or in an environment with a humidity of equal or less than 60% but equal or greater than 1%, or in an environment with a humidity of equal or less than 60% but equal or greater than 10%, or in an environment with a humidity of equal or less than 60% but equal or greater than 30%.

3. The method according to claim 1, wherein before injecting electrolyte into the dry electrochemical device, the dry electrochemical device is physically de-watered and then the electrolyte is injected into the dry electrochemical device.

4. The method according to claim 3, wherein physically de-watering the dry electrochemical device specifically comprising:
baking and/or evacuating the dry electrochemical device to reduce the moisture in the dry electrochemical device to less than 600 ppm, or to reduce the moisture in the dry electrochemical device to less than 400 ppm.

5. The method according to claim 1, wherein the step S30 specifically comprising:
injecting a first electrolyte into the dry electrochemical device and performing a first charging to the dry electrochemical device so as to remove the moisture in the dry electrochemical device, and then discharging out the first electrolyte and reaction by-products;
injecting a second electrolyte into the dry electrochemical device to obtain the electrochemical device and performing a second charging to the electrochemical device so as to complete the activation of the electrochemical device;
or,
injecting a specific electrolyte into the dry electrochemical device to obtain the electrochemical device, wherein the specific electrolyte is capable of reacting with the water in the dry electrochemical device;
charging the electrochemical device so as to complete the activation of the electrochemical device.

6. The method according to claim 5, wherein the first electrolyte does not contain a lithium salt that readily reacts with water, wherein the lithium salt that readily reacts with water comprises lithium hexafluorophosphate, wherein the components of the first electrolyte comprise at least one of LiTFSI, LiFSI and lithium perchlorate.

7. (canceled)

8. The method according to claim 5, wherein the dry electrochemical device is charged to 10%-90% SOC by the first charging, and the dry electrochemical device is charged at a constant current of less than or equal to 0.5C during the first charging.

9-10. (canceled)

11. The method according to claim 5, wherein the particular electrolyte contains an additive A, the additive A comprises at least one of anhydride compounds, silazane compounds, isocyanate compounds and imine compounds.

12. The method according to claim 11, wherein the anhydride compounds comprise at least one selected from the group consisting of propionic anhydride, maleic anhydride and sulfonic anhydride; the silazane compounds comprise at least one selected from the group consisting of hexamethyldisilazane and heptamethyldisilazane; the isocyanate compounds comprise at least one selected from the group consisting of TMSNCO and PTSI; the imine compounds comprise at least one selected from the group consisting of cyclohexylcarbodiimide and N, N-diisopropylcarbodiimide.

13. The method according to claim 1, wherein in step S10, after encapsulating the electrode assembly to obtain the dry electrochemical device, an inert gas is charged to the dry electrochemical device.

14. An electrochemical device prepared using the method of preparing an electrochemical device according to claim 1, wherein the electrochemical device is a rolled electrochemical device, the electrochemical device comprises a rolled core, a housing and an end cap, the rolled core is located in the housing; one end of the housing is provided with an opening, the end cap is provided at the opening of the housing; the end cap is provided with a gas exhaust hole and a liquid injection hole;
wherein the housing is provided with openings at opposite ends, a first end cap and a second end cap are respectively provided at the openings at the opposite ends of the housing; the gas exhaust hole and the liquid injection hole are respectively provided in the first end cap and the second end cap, or are both provided in the first end cap or in the second end cap.

15-16. (canceled)

17. The electrochemical device according to claim 14, wherein a gas exhaust valve is provided at the gas exhaust hole, and the gas exhaust valve is connected to the gas exhaust hole; and/or, a liquid injection valve is provided at the liquid injection hole, and the liquid injection valve is connected to the liquid injection hole.

18. The electrochemical device according to claim 17, wherein the gas exhaust hole is provided with a gas exhaust pipe, the gas exhaust pipe is connected to the gas exhaust hole, and the gas exhaust valve is provided in the gas exhaust pipe; and/or, the liquid injection hole is provided with a liquid injection pipe, the liquid injection pipe is connected to the liquid injection hole, and the liquid injection valve is provided in the liquid injection pipe.

19. The electrochemical device according to claim 14, wherein the rolled core is provided with a central tube in a center of the rolled core, the rolled core is formed by winding the positive electrode sheet, the diaphragm and the negative electrode sheet around the central tube;
wherein the central tube is located inside the housing, and two ends of the central tube does not extend to the outside of the housing, or
wherein the central tube is located inside the housing, and two ends of the central tube extend to the outside of the housing after passing through the end cap.

20-21. (canceled)

22. The electrochemical device according to claim 19, wherein the housing is provided with openings at opposite ends, a first end cap and a second end cap are respectively provided at the openings at the opposite ends of the housing; one end of the central tube extends through the first end cap to the outside of the housing, and the other end of the central tube extends through the second end cap to the outside of the housing.

23. The electrochemical device according to claim 19, wherein a coolant or high temperature fluid for performing temperature regulation to the electrochemical device is provided in the central tube, and the central tube is provided with a breaking hole, the breaking hole is located within the housing; a sealing material is provided in the breaking hole, and the sealing material seals the breaking hole.

24. (canceled)

25. The electrochemical device according to claim 23, wherein the sealing material is made of a material with a melting point of 70° C.-150° C.

26. The electrochemical device according to claim 14, wherein a pole is provided on the end cap, the electrochemical device further comprises a current collecting member, the current collecting member is located within the housing, and the current collecting member is electrically connected to both a tab on the rolled core and the pole.

27. The electrochemical device according to claim 26, wherein an insulating pad is provided between the pole and the end cap, and/or, an insulating member is provided between the current collecting member and the end cap.

28. A method of preparing an electrochemical device, comprising:
S10: providing a positive electrode sheet, a negative electrode sheet and a diaphragm, winding or laminating the positive electrode sheet, the diaphragm and the negative electrode sheet to form an electrode assembly, disposing the electrode assembly into a housing, and encapsulating the housing with at least one end cap to obtain a dry electrochemical device, wherein a liquid injection hole and a gas exhaust hole are provided through the at least one end cap to communicate with an interior of the housing;
S20: installing the dry electrochemical device at a position, connecting a liquid injection pipe to the liquid injection hole, and connecting a gas exhaust pipe to the gas exhaust hole;
S30: injecting electrolyte into the dry electrochemical device through the liquid injection pipe wherein gas in the housing or excessive electrolyte is discharged out through the gas exhaust hole, so as to obtain an electrochemical device; and
S40: performing initial activation to the electrochemical device.
